(19) United States
(12) Patent Application Publication
(10) Pub. No.: US 2006/0138254 A1
(43) Pub. Date: Jun. 29, 2006

(54) Nozzle for spraying a product

(75) Inventors: Jean-Louis Bougamont, Eu (FR); Christophe Roy, Dieppe (FR)

Correspondence Address: ST. ONGE STEWARD JOHNSTON & REENS LLC, 986 BEDFORD STREET, STAMFORD, CT, 06905-5619, US

(73) Assignee: Rexam Dispensing Systems S.A.S., Le Treport (FR)

(21) Appl. No.: 10/517,055

(22) PCT Filed: Jun. 6, 2003
(86) PCT No.: PCT/FR03/01701

§ 371 Date: Aug. 10, 2005

(30) Foreign Application Priority Data
Jun. 6, 2002 (FR) 02/06947

(51) Int. Cl. B05B 1/34

(52) U.S. Cl. 239/469; 239/461

(57) ABSTRACT

The invention concerns a nozzle for spraying a product, comprising a cylindro-conical body (10) having an axial channel (12) delimited at its upper end by a transverse wall (18) having a spraying orifice (20). An axial core (24) is arranged in the channel (12) and its upper end (24A) is located opposite the transverse wall (18) for delimiting therewith a spraying chamber (21). A communication between the lower end (12B) of the channel and the spraying chamber is provided between the core and the channel wall, whereof the lower end is capable of communication with a reservoir containing the product to be sprayed. The core (24) includes means forming a catching flange (26) having a catching edge (28) facing the lower end of the core and co-operating with the channel wall (13) to maintain the core in said channel.

The present invention relates to an end piece for spraying a product, comprising a cylindroconical body having an axial channel whose first end is delimited by a transverse wall exhibiting a spray orifice and whose second end is capable of communicating with a reservoir, the end piece further comprising an axial core disposed in the channel, whose first end is situated facing said transverse wall and defines with the latter a spray chamber and whose second end is situated in the vicinity of the second end of the channel, a communicating passage between said second end and the spray chamber being formed between the core and the wall of the channel.

End pieces of this type are known which serve for example in projecting a liquid pharmaceutical product into a nasal orifice.

The outlet of the pressurised reservoir is formed for example by the rod of a valve or of a pump on which the second end of the channel may be fitted in such a way that pressure on the end piece causes release, into said channel, of the product contained in the reservoir.

The presence of the core makes it possible, on the one hand, to reduce the dead volume inside the channel, which makes it possible, on actuation of the end piece, to increase the pressure in this channel very rapidly so as to expel effectively the product coming from the reservoir. This also makes it possible to prevent stagnation in the channel of a large quantity of product, which could be contaminated.

Furthermore, the core serves to define the spray chamber, with the transverse wall of the body.

The geometric definition of this spray chamber must be precise, because the product spray quality is frequently dependent thereon. For example, a swirling movement may be sought at the time of spraying, in which case the product has to enter the expulsion chamber in a swirling stream, the swirl component being maintained at the time of expulsion of the product through the spray orifice.

It is therefore important for the core to be positioned precisely relative to the channel and, in particular, relative to the transverse wall of the body, so as to define precisely the geometry of the spray chamber.

In general, the core is an elongate element and its length may vary as a function of manufacturing tolerances. A variation in length may result in poor positioning of the core and therefore impair spray quality.

The invention aims to remedy these disadvantages by improving positioning of the core relative to the channel in which it is situated.

This object is achieved as a result of the fact that the core exhibits means forming a fastening flange having a fastening edge which is directed towards the second end of the core and which cooperates with the wall of the channel to retain the core in said channel.

Thus, when the end piece is assembled, the core is normally inserted into the channel in the cylindroconical body by being pushed towards the transverse wall of the first end of the channel, from the second end of the latter. Since the fastening edge of the means forming the fastening flange is directed towards the second end of the core, this pushing action is not prevented. It is only when the core arrives in its final position that its progress in the channel stops. In this final position, the core is jammed inside the channel thanks to the fastening edge of the means forming the flange. It is therefore positioned suitably for a first instance of use of the end piece. Furthermore, it is held perfectly in place, such that the position does not vary during multiple instances of use of the end piece, and the spray quality remains unchanged over time.

Of course, the means forming the fastening flange are formed so as to maintain communication between the second end of the channel and the spray chamber.

Thus, advantageously, the spray chamber is formed by a cavity defined between the transverse wall of the body and the first end of the core abutting against said wall, said cavity comprising at least one non-radial slot formed in the first end of the core or the transverse wall.

Advantageously, the means forming the fastening flange take the form of at least one annular flange sector delimited by a slot.

For example, on either side of the means forming the flange, a communicating passage between the second end of the channel and the spray chamber is formed by a space between the wall of the channel and the core. This communicating passage also comprises the above-stated slot.

Advantageously, the means forming the flange have a plurality of sectors, so as to form at least two or three slots, which are angularly equidistant so as to maintain uniformity of distribution of the product from the reservoir to the spray chamber.

According to an advantageous configuration, the channel has a fastening portion, with which the flange cooperates and over which the diametral dimensions of the channel are less than the diametral dimensions of the flange, and an insertion portion, which extends between the fastening portion and the second end of the channel and over which the diametral dimensions of the channel are at least substantially equal to those of the flange.

As indicated previously, on assembly of the end piece the core is inserted into the channel via the second end of the latter. Over the entire length of the insertion portion, and due to appropriate selection of the diametral dimensions of the channel over this portion, progress of the core is easy. It is only when the flange arrives in the region of the fastening portion that this progress becomes more difficult, and the flange jams naturally.

Advantageously, the core exhibits means forming an axial bearing surface, which means cooperate with the wall of the channel.

For example, the core exhibits at least one radially projecting sector of a cylinder delimited by a slot.

Thus, advantageously, the above-mentioned annular flange sector takes the form of a shoulder situated at the end of the cylinder sector which is directed towards the second end of the core.

These means forming an axial bearing surface promote alignment of the longitudinal axis of the core and that of the channel.

Advantageously, the core exhibits, at its second end, an end portion of reduced diameter around which an annular space is defined in the channel.

This annular space defined in the channel allows the introduction of a rod providing a connection to the reservoir (in particular the rod of a valve or a pump) into the channel and around the second end of the core.

Thus, advantageously, the second end of the channel is plugged together with the tubular rod providing connection to the reservoir and the second end of the core is engaged in said rod.

In this case, advantageously, the second end of the core is in axially bearing contact with the inner periphery of the rod and at least one flow groove is formed between said second end and said inner periphery.

Advantageously, the core is bevelled at its second end.

This bevel forms a ramp which, when said tubular rod is introduced into the above-mentioned annular space, promotes said introduction.

Advantageously, the wall of the channel exhibits a shoulder in the vicinity of the second end of said channel and the core extends, towards the second end of the channel, beyond said shoulder.

This shoulder serves in particular to define the position of the outlet tube of the reservoir inside the channel.

The invention will be better understood and its advantages will become more apparent on reading the detailed description which follows of an embodiment represented by way of non-limiting example.

The description refers to the appended drawings, in which:

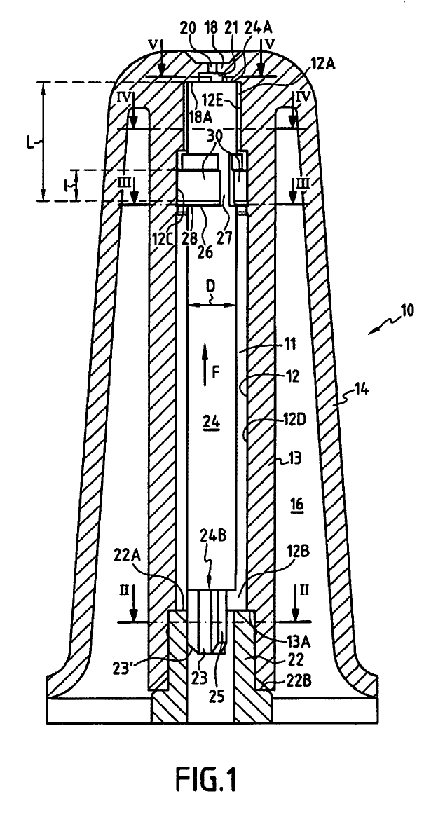

FIG. 1 is a view in axial section of an end piece according to the invention;

FIGS. 2, 3, 4 and 5 are respectively sections along lines II-II, III-III, IV-IV and V-V of FIG. 1;

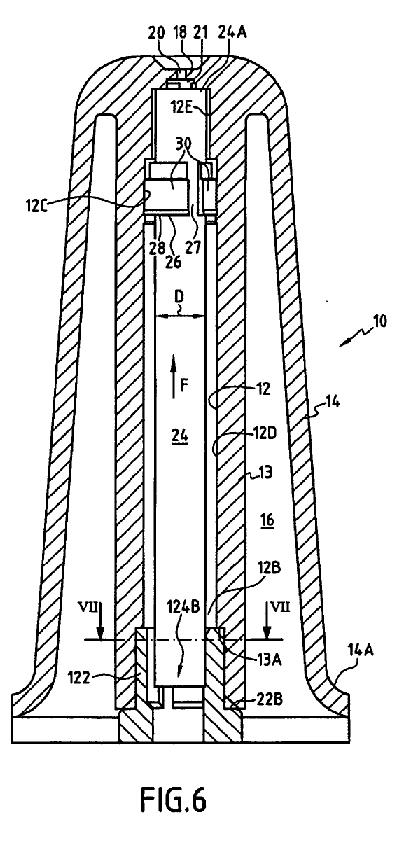

FIG. 6 is a section similar to that of FIG. 1, illustrating a variant embodiment; and

FIG. 7 is a section along line VII-VII of FIG. 6.

The end piece shown in FIG. 1 comprises a cylindroconical body 10 having an axial channel 12. This channel is surrounded by a cylindroconical skirt 14, with which it is made in one piece to form the body 10. An internal space 16 is formed between the wall 13 of the channel 12 and the skirt 14.

The first end 1 2A of the channel is delimited by a transverse wall 18 having a spray orifice 20. In the case in point, this transverse wall 18 is formed in one piece with the body 10.

The second end 12B of the channel is open, which allows it to communicate with a reservoir containing the product needing to be sprayed. In all the rest of the description, it will be assumed that the channel is arranged vertically, and that its first and second ends 12A and 12B are respectively the upper and lower ends.

The lower end 1 2B of the channel is fitted on a tubular rod 22 providing a connection to the reservoir. In particular, this rod may be that of a valve associated with a pressurised reservoir or of a pump. The position of this rod in the channel is defined by a shoulder 13A, exhibited by the wall 13 of the channel at its inner periphery and with which the free end 22A of the rod 22 cooperates in the manner of a limit stop.

Said rod itself has, on its outer periphery, a shoulder 22B which may be used to define the position of maximum penetration of the rod in the channel, by cooperation between said shoulder 22B and the free end of the wall 13.

Towards its lower end, the skirt 14 has pressure surfaces 14A (formed for example on fins or on a flange) which make it possible to push the end piece downwards to actuate the valve and thus release the product contained in the reservoir.

An axial core 24 is disposed in the channel 12. The upper end 24A of said core is situated facing the inner face of the above-mentioned transverse wall 18. Its lower end 24B is situated in the vicinity of the lower end 12B of the channel.

The core comprises means forming a fastening flange which keep it fastened inside the channel by cooperating with the inner periphery of the wall 13 of the latter.

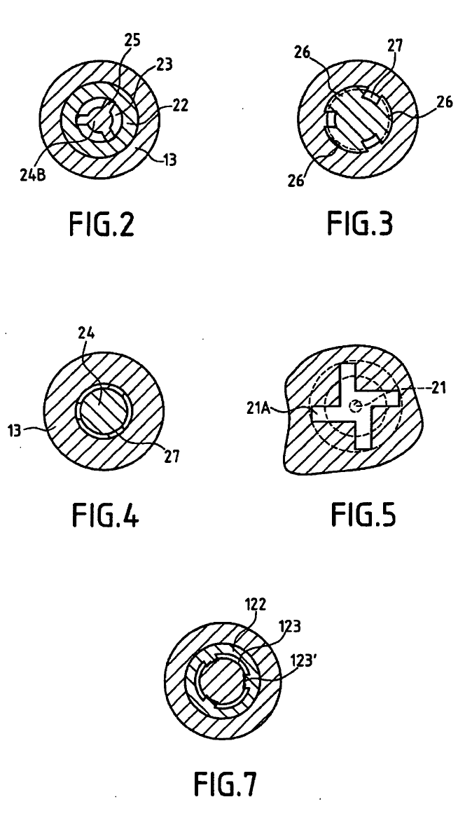

In the case in point, as can be seen better in FIG. 3, these means forming a flange take the form of three annular flange sectors 26 which are separated from one another by slots 27.

It can be seen that each of these flange sectors exhibits a fastening edge 28 which is directed towards the lower end 24B of the core.

Thus, these fastening edges do not oppose insertion of the core into the channel by displacement of this core in the upward direction F. In addition, on their upper faces the flange sectors are shaped like inclined ramps.

On the other hand, the fastening edges cooperate with the inner face of the wall 13 of the channel in order to oppose downward displacement of the core, once the latter is in place in the channel.

It should be noted that this fastening may be promoted by the fact that the core 24 is made of a harder material than the body 10. For example, the core is moulded from polypropylene, whereas the body is moulded from polyethylene.

The core is also retained in relation to displacement in the direction F, once it has reached its final position, through abutment of its upper end 24A against the inner face 18A of the transverse wall 18.

In this final position, the means forming the flange 26 are located in a portion of the channel which forms a fastening portion 12C. In effect, at this point, the diametral dimensions of the channel are less than those of the means forming the flange, as is shown clearly in FIG. 3.

The core has overall the form of a cylinder of circular section, its diameter varying in the region of the flange sectors and, optionally, at its lower end 24B.

The channel furthermore comprises an insertion portion 12D over which its diametral dimensions are at least substantially equal to those of the means forming the flange. This insertion portion extends from the lower end of the channel as far as the fastening portion 12C.

The means forming the flange are situated in the vicinity of the upper end 24A of the core, from which they are distant by a length L corresponding for example to approximately a third or a quarter of the total length of said core. The channel 12 has an upper portion 12E, which extends from the fastening portion 12C to the upper end of said channel and which has diametral dimensions which are slightly smaller again than those of the fastening portion.

A communicating passage is formed between the core and the wall of the channel, to allow the liquid leaving the valve rod 22 to flow as far as the spray chamber 21, which is formed between the upper end 24A of the core and the wall 18.

Thus, over the entire length of the channel, except in the region in which are situated the means forming the fastening flange, there is formed an annular space 11 between the core and the inner wall of the channel. The above-mentioned slots 27 establish continuity of communication in said space, in the region of said means forming the flange.

The core 24 has means forming an axial bearing surface which, in the case in point, are disposed between the flange and the upper end 24A of the core. They thus cooperate with the wall of the channel, in the region of the fastening portion 12C. These means take the form of at least one radially projecting cylinder sector 30, delimited by a slot.

In the case in point, three cylinder sectors 30 are provided, which each extend as axial extensions of the annular flange sectors 26, and the slots 27 extend axially between these flange sectors and these cylinder sectors. More precisely, each annular flange sector 26 takes the form of a shoulder which is situated at the end of a cylinder sector 30 directed towards the second end 24B of the core.

In fact, in the region of the slots 27, the diametral dimensions of the core are reduced to its standard diametral dimensions D.

The axial bearing means formed by the sectors 30 define, on the core, axial wall portions which rest against the inner face of the wall 13 of the core and whose axial length l forms an axial bearing length between the core and the channel. To ensure alignment of the core relative to the channel, additional axial bearing means, described below, may be provided.

The chamber 21 is defined between the upper end 24A of the core and the wall 18. As can be seen in FIG. 5, this cavity comprises non-radial slots 21A which, in the case in point, are formed in the inner face of the wall 18. Although it is not visible in the section of FIG. 5, the position of the spray orifice 21 has been indicated in this Figure, and it will be understood that the sprayed product, which enters the chamber 21 via the ends of the slots 21A communicating with the annular space formed between the core and the channel, has imparted to it in this chamber a swirling movement which allows it to be sprayed in swirling manner through the orifice 21.

The core is correctly positioned due to the presence of the means forming the fastening flange, which retain it with regard to displacement which would wrench it out of the channel, and to that of the above-defined bearing means.

However, another feature of the invention makes it possible to ensure good positioning of the core. In effect, as can be seen in FIG. 1, an annular space is defined in the channel around the lower end portion 24B of the core. The upper end of the tubular rod 22 may be inserted into this annular space, and this end portion 24B can thus be seen to be inserted into this rod 22.

In the example of FIG. 1, this end portion 24B has a reduced diameter and exhibits protruding axial fins 25 which bring its maximum diametral dimensions to the diameter of the core.

These fins cooperate with the inner periphery of the tubular rod 22, so as to align the axis of the core with that of said rod.

In other words, these fins form axial bearing means between the core and the inner periphery of the rod, whilst flow grooves 23 are formed between them and this inner periphery so as to allow communication between the reservoir and the channel.

To facilitate positioning of the rod 22 in the channel and any recentring of the core which may be necessary, its lower end is bevelled. In the case in point, the fins have bevels 23′.

The variant of FIG. 6 differs from that of FIG. 1 in the configuration of the lower end portion 124B of its core 24 and in that of the tubular rod 122. In effect, the diameter D of the core is unchanged in its lower end portion 124B relative to its standard portion. This portion 124B is however engaged in the rod 122 and is in axially bearing contact with the inner periphery of this rod. Flow grooves are formed by slots 123 in the inner periphery of said rod, the ribs 123′ formed between these slots cooperating with the periphery of the core, to achieve the above-mentioned axial bearing contact.

With the invention, the position of the core inside the channel is perfectly maintained. Furthermore, the axes of this core and of the channel may be perfectly aligned, which makes it possible to arrange the upper face 24A of the core, which is generally perpendicular to the axis thereof, in an optimum position bearing against the lower face of the wall 18. Thus, the partial closure of the channels 21A achieved by the upper face of the core is correctly achieved, without angular misalignment of the core relative to the channel. In this manner, swirling movement is perfectly ensured.

The core is wedged in the channel, but it is by the fastening edge of the means forming the flange and not by the valve rod that it is retained with regard to downward displacement. Since the rod additionally abuts against the body of the end piece, pressure on the end piece to spray the product contained in the reservoir is exerted directly on the valve rod, without exerting axial stress on the core.

1. An end piece for spraying a product, comprising a cylindroconical body having an axial channel whose first end is delimited by a transverse wall exhibiting a spray orifice and whose second end is capable of communicating with a reservoir, the end piece further comprising an axial core disposed in the channel, whose first end is situated facing said transverse wall and defines with the latter a spray chamber and whose second end is situated in the vicinity of the second end of the channel, a communicating passage between said second end and the spray chamber being formed between the core and the wall of the channel,
wherein the core comprises a fastening flange having a fastening edge which is directed towards the second end of the core and which cooperates with the wall of the channel to retain the core in said channel.

2. An end piece according to claim 1, wherein the fastening flange comprises at least one annular flange sector delimited by a slot.

3. An end piece according to claim 1, wherein the channel has a fastening portion, with which the flange cooperates and over which the diametral dimensions of the channel are less than the diametral dimensions of said flange, and an insertion portion, which extends between the fastening portion and the second end of the channel and over which the diametral dimensions of the channel are at least substantially equal to those of the flange.

4. An end piece according to claim 1, wherein the core exhibits means forming comprises an axial bearing surface, which cooperates with the wall of the channel.

5. An end piece according to claim 4, wherein the core comprises at least one radially projecting cylinder sector delimited by a slot.

6. An end piece according to claims 2, wherein the annular flange sector is formed by a shoulder situated at the end of the cylinder sector which is directed towards the second end of the core.

7. An end piece according to claim 1, wherein the spray chamber is formed by a cavity defined between the transverse wall of the body and the first end of the core abutting against said wall, said cavity comprising at least one non-radial slot formed in the first end of the core or the transverse wall.

8. An end piece according to claim 1, wherein the core comprises, at its second end, an end portion of reduced diameter around which an annular space is defined in the channel.

9. An end piece according to claim 8, wherein the end portion comprises protruding axial fins.

10. An end piece according to claim 1, wherein the core is bevelled at its second end.

11. An end piece according to claim 1, wherein the wall of the channel comprises a shoulder in the vicinity of the second end of said channel and in that the core extends, towards the second end of the channel, beyond said shoulder.

12. An assembly of an end piece according to claim 1, and a tubular rod providing connection to a reservoir, wherein the second end of the channel is plugged together with the tubular rod and the second end of the core is engaged in said rod.

13. An assembly according to claim 12, wherein the second end of the core is in axially bearing contact with the inner periphery of the rod and in that at least one flow groove is formed between said second end and said inner periphery.

14. An assembly according to claim 13 having an end piece according to claim 9, wherein the fins cooperate with the inner periphery of the rod and the spaces between said fins form flow grooves.

15. An assembly according to claim 13, wherein the flow groove is formed by at least one slot in the inner periphery of the rod.

16. An end piece according to claim 2, wherein the channel has a fastening portion, with which the flange cooperates and over which the diametral dimensions of the channel are less than the diametral dimensions of said flange, and an insertion portion, which extends between the fastening portion and the second end of the channel and over which the diametral dimensions of the channel are at least substantially equal to those of the flange.

17. An end piece according to claim 16, wherein the core comprises an axial bearing surface which cooperates with the wall of the channel.

18. An end piece according to claim 17, wherein the core comprises at least one radially projecting cylinder sector delimited by a slot.

19. An end piece according to claim 2, wherein the core comprises an axial bearing surface which cooperates with the wall of the channel.

20. An end piece according to claim 19, wherein the core comprises at least one radially projecting cylinder sector delimited by a slot.
